(19) United States
(12) Patent Application Publication
(10) Pub. No.: US 2011/0205595 A1
(43) Pub. Date: Aug. 25, 2011

(54) SYSTEM FOR CREATING MEDIUM HAVING IMAGE LAID OUT THEREON, METHOD FOR CONTROLLING THE SYSTEM, INFORMATION PROCESSING APPARATUS IN THE SYSTEM, AND METHOD FOR CONTROLLING THE INFORMATION PROCESSING APPARATUS

(75) Inventor: Tatsuya Yamamoto, Tokyo (JP)

(73) Assignee: CANON KABUSHIKI KAISHA, Tokyo (JP)

(21) Appl. No.: 13/032,404

(22) Filed: Feb. 22, 2011

(30) Foreign Application Priority Data
Feb. 23, 2010 (JP) PCT/JP2010/052713

(51) Int. Cl. G06K 15/00

(52) U.S. Cl. 358/1.18

(57) ABSTRACT

A preferred method is provided for promoting sales in a system that is designed for creating a medium having one or more images laid out thereon. More specifically, an image removed from a predetermined layout frame by an image replacement operation during a layout operation for laying out an image in the predetermined layout frame is identified. Then, at least one image identified is determined to be a recommended image whose purchase is to be recommended.

### FIELD OF THE INVENTION

The present invention relates to a system for creating a medium having one or more images laid out thereon.

### DESCRIPTION OF THE RELATED ART

Conventionally, photo studios that take wedding pictures and family pictures have made presentations so that users can select an image to purchase from a plurality of images taken and also select an item, such as a photo book, on which the selected image is to be printed. However, such presentations are time consuming and it is difficult to pay detailed attention to each of a plurality of users. Additionally, the users may not be able to take time to carefully consider which image to purchase in combination with which item, and thus may not be able to purchase a desired product.

Thus, as described in Japanese Patent Laid-Open No. 2005-12649, a system has been proposed in which images taken at a photo studio can be uploaded to a server on a network, so that users can access the server from their home PCs and select images to purchase.

Also, services have been recently provided which allow users to create a photo book from images taken by the users, using dedicated editing software, and order the photo book via the Internet.

In the method described in Japanese Patent Laid-Open No. 2005-12649, users can freely select images and items to purchase. However, since photo studios cannot make sales pitches for promotion, the method may not necessarily lead to an increase in sales. For example, since the number of images that can be laid out on a photo book is limited, users may give up purchasing some of images after wondering whether to purchase.

An object of the present invention is to provide a preferred method for promoting sales in a system that is designed for creating a medium having one or more images laid out thereon.

### SUMMARY OF INVENTION

To solve the problems described above, the present invention provides a system for creating a medium having one or more images laid out thereon, the system including a storage unit adapted to store an operation history relating to layout operations, each laying out an image in a layout frame included in a first medium; an identifying unit adapted to identify, on the basis of the operation history stored in the storage unit, an image removed from the layout frame by an image replacement operation; a first determining unit adapted to determine at least one image identified by the identifying unit to be a recommended image whose purchase is to be recommended; a second determining unit adapted to determine a second medium to be recommended as a layout target on which the recommended image determined by the first determining unit is to be laid out; and a presenting unit adapted to present the recommended image and the second medium to a user.

The present invention further provides a control method in a system for creating a medium having one or more images laid out thereon, the control method including obtaining an operation history relating to layout operations, each laying out an image in a layout frame included in a first medium; identifying, on the basis of the obtained operation history, an image removed from the layout frame by an image replacement operation; determining at least one identified image to be a recommended image whose purchase is to be recommended; determining a second medium to be recommended as a layout target on which the recommended image is to be laid out; and presenting the recommended image and the second medium to a user.

The present invention further provides a information processing apparatus in a system for creating a medium having one or more images laid out thereon, the information processing apparatus including an identifying unit adapted to identify an image removed from a predetermined layout frame by an image replacement operation during a layout operation for laying out an image in the predetermined layout frame; and a determining unit adapted to determine at least one image identified by the identifying unit to be a recommended image whose purchase is to be recommended.

The present invention further provides a control method for controlling an information processing apparatus in a system for creating a medium having one or more images laid out thereon, the control method including identifying an image removed from a predetermined layout frame by an image replacement operation during a layout operation for laying out an image in the predetermined layout frame; and determining at least one identified image to be a recommended image whose purchase is to be recommended.

Further features of the present invention will become apparent from the following description of exemplary embodiments with reference to the attached drawings.

### BRIEF DESCRIPTION OF DRAWINGS

FIG. 1 illustrates a configuration of a system applicable to the present invention.

FIG. 2 illustrates a configuration of hardware of a PC 104.

FIG. 3 illustrates functional blocks of the PC 104.

FIG. 4A and FIG. 4B illustrate examples of a layout operation screen.

FIG. 5 illustrates an example of a history of layout operations.

FIG. 6 is a flowchart illustrating an operation of the PC 104 according to a first embodiment.

FIG. 7A and FIG. 7B illustrate examples of recommendation display.

FIG. 8 is a flowchart illustrating an operation of the PC 104 according to a second embodiment.

FIG. 9 is a flowchart illustrating an operation of the PC 104 according to a third embodiment.

FIG. 10 is a flowchart illustrating an operation of the PC 104 according to a fourth embodiment.

### DESCRIPTION OF EMBODIMENTS

Hereinafter, with reference to the attached drawings, a detailed description will be given on the basis of preferred embodiments of the present invention. It is to be understood that configurations to be described in the following embodiments are merely examples, and the present invention is not limited to the illustrated configurations.

### First Embodiment

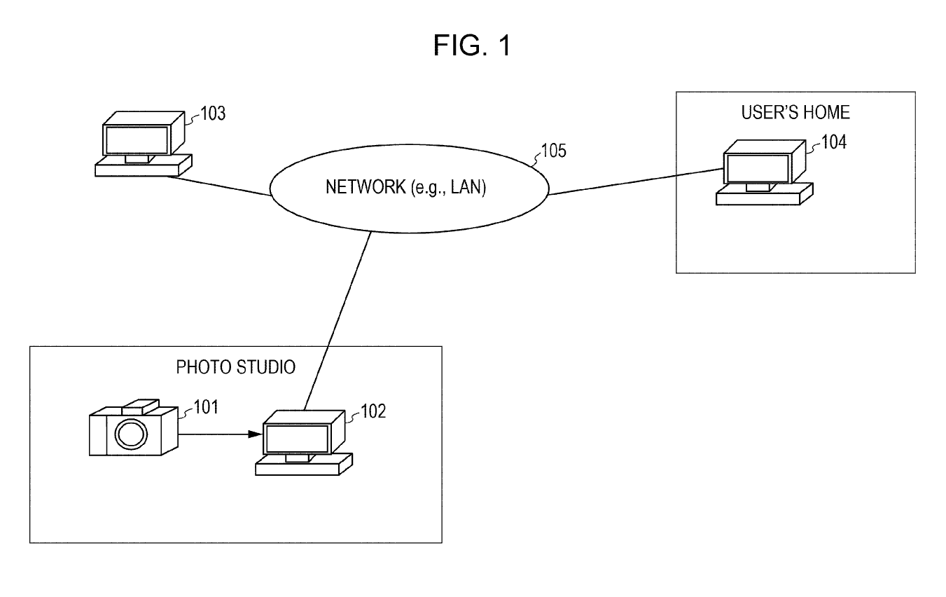

FIG. 1 illustrates a configuration of a system for selling laid-out items, each having one or more images laid out thereon. In FIG. 1, reference numeral 101 denotes a camera, reference numeral 102 denotes a photo-studio management apparatus, reference numeral 103 denotes a management server, reference numeral 104 denotes a personal computer (hereinafter referred to as a PC), and reference numeral 105 denotes a network.

A photographer for a photo studio operates the camera 101 to take several tens to several hundreds of pictures of a user in different poses and clothes. The images thus taken are stored, for example, on a hard disk of the photo-studio management apparatus 102 via a memory card in the camera 101, or via a communication cable such as a USB cable.

The photo-studio management apparatus 102 is connected to the management server 103 via the network 105, such as a local area network (LAN). The images taken are transmitted from the photo-studio management apparatus 102 to the management server 103.

The PC 104 is at a user's home. The management server 103 is accessible from the PC 104 via the network 105. The PC 104 is capable of allowing the user to view websites. The user accesses and logs in to the management server 103 using the PC 104 to view images transmitted from the photo-studio management apparatus 102 to the management server 103. By using a print order screen provided by the management server 103, the user can lay out any image on any item while viewing images, and can order an item on which image layout has been completed (hereinafter referred to as a laid-out item). Order information indicating the user's order is transmitted to the management server 103.

The photo-studio management apparatus 102 communicates with the management server 103 to check the order information. On the basis of the checked order information, the photo studio creates a laid-out item and delivers it to the user's home.

In the present specification, the term “item” refers to a medium on which one or more images are to be printed. Examples of the item include, but are not limited to, a photo book (album), a photo mount, a calendar, a postcard, a key chain, and a sticker.

The present embodiment describes a method in which, on the basis of an operation history indicating image layout operations performed by the user on any item, an image whose purchase is to be recommended and an item to be recommended as a layout target on which the image is to be laid out are presented to the user.

In the system configuration described above, the user places an order from the PC 104 at home. Alternatively, the user may place an order from a PC or a dedicated apparatus at the photo studio. In the description above, the management server 103 is located in a place different from the photo studio. Alternatively, the management server 103 may be located at the photo studio. The photo-studio management apparatus 102 and the management server 103 do not necessarily need to be separate, and may be configured as a single unit.

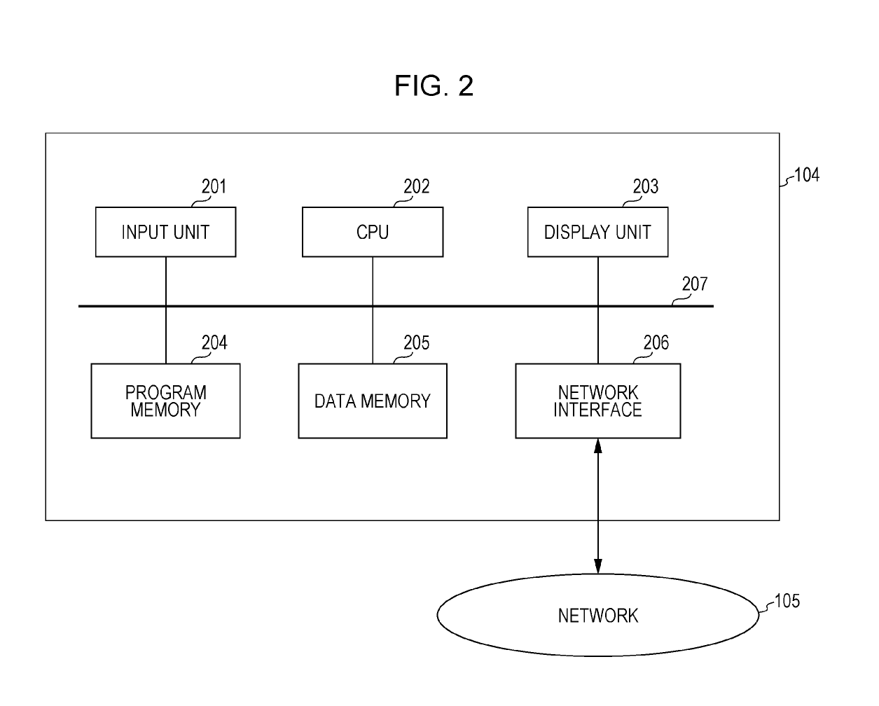

FIG. 2 is a block diagram illustrating an example of a configuration of hardware of the PC 104 applicable to the present invention.

Reference numeral 201 denotes an input unit that the user uses to input various types of information. Examples of the input unit 201 include a keyboard and a mouse. Reference numeral 202 denotes a CPU that performs arithmetic operations and logical decisions for various types of processing, and controls each component connected to a bus 207 (described below). Reference numeral 203 denotes a display unit that displays various types of information. The display unit 203 is a display, such as an LCD or a CRT.

Reference numeral 204 denotes a program memory that stores a program including a processing procedure of a flowchart (described below). The program memory 204 may either be a ROM or a RAM into which the program is loaded from an external storage device (not shown) or the like.

Reference numeral 205 denotes a data memory that stores data generated by various types of processing. History information about layout operations (described below) is stored in the data memory 205. The data memory 205 is, for example, a RAM. Data may be loaded from a nonvolatile external storage medium into the data memory 205 before processing, or may be referred to as necessary.

Reference numeral 206 denotes a network interface for communication via the network 105.

Reference numeral 207 denotes a bus for transferring an address signal indicating each component to be controlled by the CPU 202, a control signal for controlling each component, and data that is transmitted and received between components.

The PC 104 further includes external storage devices, such as a storage drive unit and a hard disk, for reading and writing from and to a storage medium, such as a DVD, but the configurations of these external storage devices will not be described here.

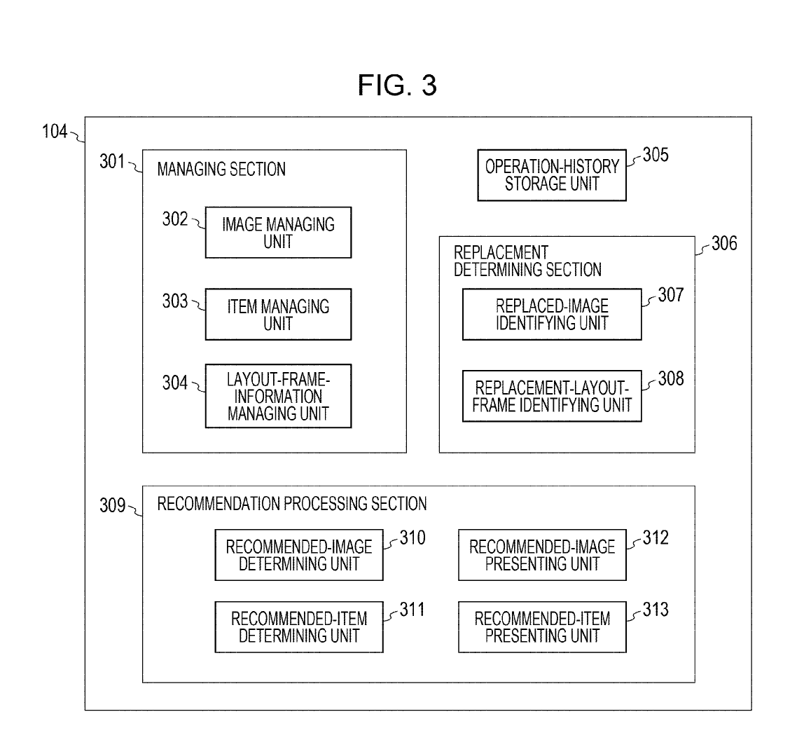

FIG. 3 is a block diagram illustrating an example of functional blocks of the PC 104 applicable to the present invention.

Reference numeral 301 denotes a managing section that manages various types of information. The managing section 301 includes an image managing unit 302, an item managing unit 303, and a layout-frame-information managing unit 304.

The image managing unit 302 obtains information about a plurality of images taken at the photo studio from the management server 103 and manages the obtained information.

The item managing unit 303 obtains, from the management server 103, information about a plurality of types of items that can be ordered and manages the obtained information. The item managing unit 303 also manages the number of images that can be laid out on each item.

The layout-frame-information managing unit 304 manages various types of information, such as the shape and size of a layout frame in each item.

Reference numeral 305 denotes an operation-history storage unit that stores a history related to layout operations (described below).

Reference numeral 306 denotes a replacement determining section that makes a determination for an image replacement operation (described below). The replacement determining section 306 includes a replaced-image identifying unit 307 and a replacement-layout-frame identifying unit 308.

The replaced-image identifying unit 307 identifies, on the basis of an operation history stored in the operation-history storage unit 305, an image removed by an image replacement operation from images to be laid out on a selected item.

The replacement-layout-frame identifying unit 308 identifies a layout frame in which the image identified by the replaced-image identifying unit 307 was laid out.

Reference numeral 309 denotes a recommendation processing section that performs various types of processing for recommending images and items to be purchased. The recommendation processing section 309 includes a recommended-image determining unit 310, a recommended-item determining unit 311, a recommended-image presenting unit 312, and a recommended-item presenting unit 313.

The recommended-image determining unit 310 determines, of a plurality of images managed by the image managing unit 302, at least one image identified by the replaced-image identifying unit 307 to be an image (recommended image) whose purchase is to be recommended to the user.

The recommended-item determining unit 311 determines an item (recommended item) to be recommended as a layout target on which the recommended image determined by the recommended-image determining unit 310 is to be laid out.

The recommended-image presenting unit 312 and the recommended-item presenting unit 313 display information on the display unit 203 to encourage the user to purchase the recommended image and the recommended item determined by the recommended-image determining unit 310 and the recommended-item determining unit 311, respectively.

All the functional blocks are mutually related to each other in terms of software or hardware. For example, the functional blocks denoted by reference numerals 301 to 305 are realized by the data memory 205. The functional blocks denoted by reference numerals 306 to 313 are realized when the CPU 202 executes the program stored in the program memory 204. The functional blocks described above are merely an example. A plurality of functional blocks may constitute a single functional block, or any functional block may be divided into blocks that perform a plurality of functions.

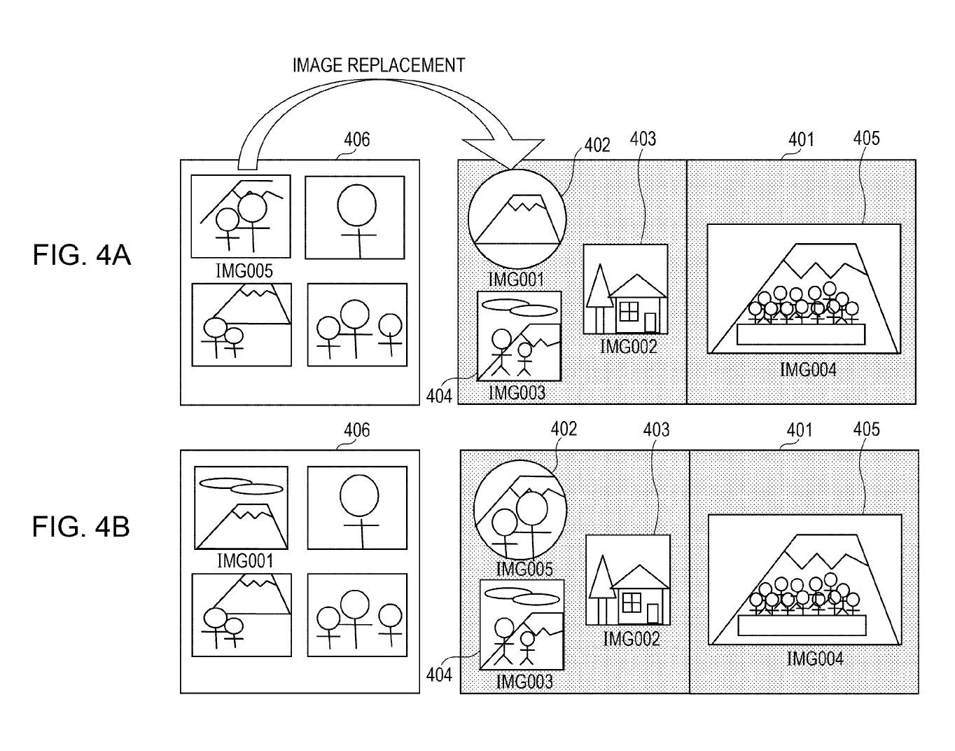

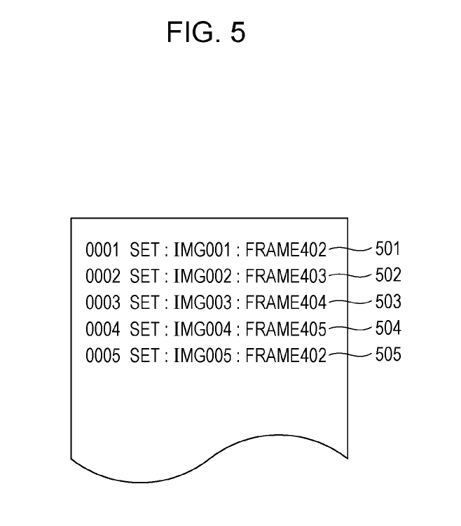

Layout operations for laying out images on an item according to present embodiment will be described with reference to FIG. 4A, FIG. 4B, and FIG. 5.

FIG. 4A and FIG. 4B illustrate examples of a layout operation screen displayed on the display unit 203 of the PC 104. FIG. 4A illustrates a layout operation screen displayed before an image replacement operation (described below) is performed. FIG. 4B illustrates a layout operation screen displayed after the image replacement operation is performed.

Reference numeral 401 denotes an item display area for displaying an item selected as a layout target. Here, a photo book is selected from a plurality of items. Reference numerals 402 to 405 denote layout frames for laying out any images. Reference numeral 406 denotes a candidate-image display area for displaying candidate images to be laid out in the layout frames 402 to 405. For example, by using drag-and-drop, the user can select any image from candidate images displayed in the candidate-image display area 406, move the selected image to any layout frame in the item display area 401, and thus freely lay out the image. In the example of FIG. 4A, images 001 to 004 are laid out in the layout frames 402 to 405, respectively.

Assume that in consideration of, for example, balance among subjects within the photo book, the user thinks it is better to lay out an image 005 instead of the image 001, and performs a replacement operation to replace the image 001 with the image 005. Specifically, the user moves the image 005 to the layout frame 402 using drag-and-drop. Thus, as illustrated in FIG. 4B, the image 005 is laid out in the layout frame 402 and the image 001 is displayed in the candidate-image display area 406.

An image replaced with another image by such an image replacement operation is likely to be one that the user wondered whether to purchase. Therefore, the present embodiment will describe a method in which sales can be promoted by recommending the user to lay out such a replaced image on another item and purchase the image along with the item. In the following description, an image that was in a layout frame and has been removed from the layout by laying out another image in the layout frame will be referred to as a “replaced image”.

In the above description, replacement of an image already laid out in a layout frame is done by moving another image to the position of the layout frame using drag-and-drop. However, replacement may be done differently. For example, an image already laid out in a layout frame may be temporarily moved out of the item display area 401 using drag-and-drop so that another image can be moved to the layout frame. Although identification information for each image (IMG001 to IMG005) is shown in FIG. 4A and FIG. 4B for ease of understanding, the display of such identification information may be omitted.

The user may perform a page turning operation, using the input unit 201, to display another page of the photo book and continue the layout operation. Pressing a layout completion button (not shown) ends the layout operation, and switches the display from the layout operation screen to an order confirmation screen (i.e., a screen for confirmation of price, quantity, etc.).

FIG. 5 illustrates an example of a history of layout operations described with reference to FIG. 4A and FIG. 4B. The illustrated operation history is stored in the operation-history storage unit 305.

Reference numeral 501 indicates that the image 001 has been laid out in the layout frame 402. Similarly, reference numerals 502 to 504 indicate that the images 002 to 004 have been laid out in the layout frames 403 to 405, respectively. Reference numeral 505 indicates that the image 005 has been laid out in the layout frame 402. Thus, an operation history is stored in which identification information for each image is associated with identification information for a layout frame where the image is laid out.

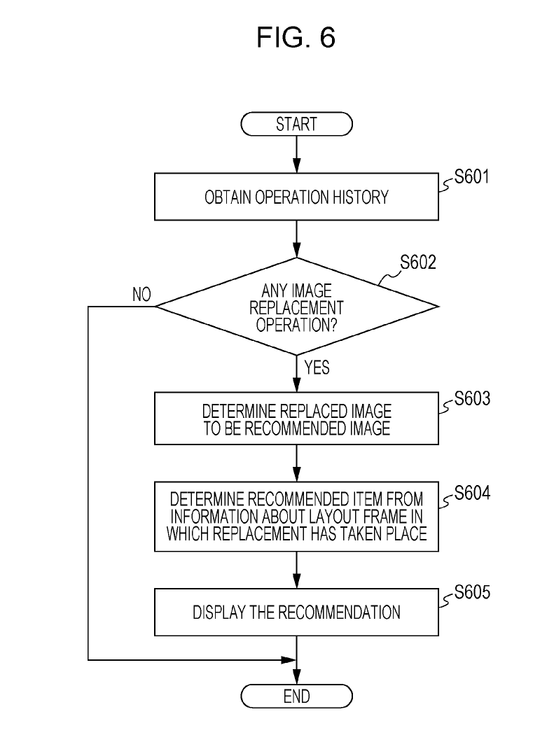

FIG. 6 is a flowchart illustrating an operation of the PC 104 according to the present embodiment. The flow of FIG. 6 starts, for example, when the layout completion button is pressed after the layout operations illustrated in FIG. 4A and FIG. 4B.

First, the replacement determining section 306 obtains an operation history stored in the operation-history storage unit 305 (step S601) and determines whether any image replacement operation has taken place (step S602). Specifically, if more than one piece of information about the same layout frame appears in the operation history, and different images have been laid out in this layout frame, the replacement determining section 306 determines that an image replacement operation has taken place. In the case of FIG. 5, information about the layout frame 402 appears at the points of reference numerals 501 and 505 and indicates that the images 001 and 005 have been laid out in the layout frame 402. Therefore, the replacement determining section 306 determines that an image replacement operation has taken place.

Then, the replaced-image identifying unit 307 identifies the image 001 replaced with the image 005 by the replacement operation as a replaced image. At the same time, the replacement-layout-frame identifying unit 308 identifies the layout frame 402 in which the replaced image 001 was laid out before being replaced. If replacement operations have taken place in a plurality of layout frames, the corresponding replaced images and replacement layout frames are identified. If the replacement determining section 306 determines that any image replacement operation has taken place (YES in step S602), the process proceeds to step S603. If the replacement determining section 306 determines that no replacement operation has taken place (NO in step S602), the process ends.

In step S603, the recommended-image determining unit 310 determines the replaced image 001 identified by the replaced-image identifying unit 307 to be an image whose purchase is to be recommended. That is, the recommended-image determining unit 310 regards an image replaced with another image by a replacement operation as one that the user wondered whether to purchase, and makes a recommendation to the user to print the image on another item and purchased it.

Next, on the basis of information about the layout frame 402 identified by the replacement-layout-frame identifying unit 308, the recommended-item determining unit 311 determines an item to be recommended as a layout target on which the replaced image 001 determined by the recommended-image determining unit 310 is to be laid out (step S604). Specifically, on the basis of information managed by the layout-frame-information managing unit 304, the recommended-item determining unit 311 determines an item having a layout frame with a shape identical or similar to that of the layout frame 402 to be a recommended item.

In step S605, the recommended-image presenting unit 312 and the recommended-item presenting unit 313 display the recommended image determined by the recommended-image determining unit 310 and the recommended item determined by the recommended-item determining unit 311 to encourage the user to purchase them.

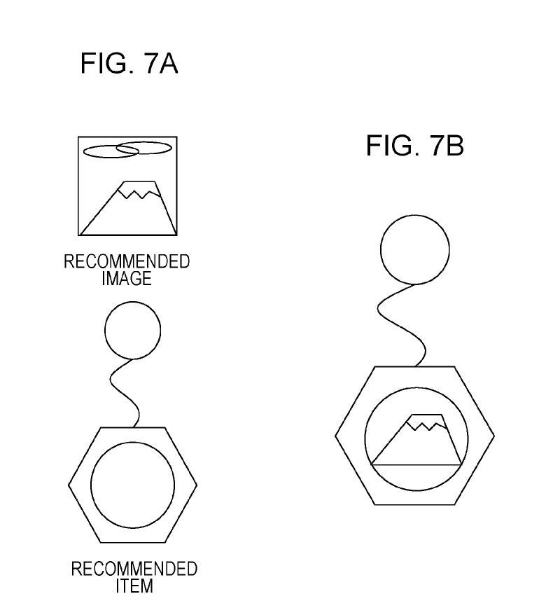

Examples of recommendation display are illustrated in FIG. 7A and FIG. 7B. FIG. 7A illustrates an example of display where the image 001 determined to be a recommended image and a key chain determined to be a recommended item are arranged in line. As described with reference to FIG. 4A and FIG. 4B, the layout frame 402 in which the image 001 was laid out before a replacement operation has a circular shape. Therefore, a key chain having a circular layout frame is selected as a recommended item. FIG. 7B illustrates an example of display where the recommended image 001 is laid out in the layout frame of the key chain selected as a recommended item. Although not illustrated here, a message such as “This is a recommended product for you. Would you like to purchase it?” may also be displayed.

In step S604 of FIG. 6, a recommended item is determined on the basis of the shape of the layout frame identified by the replacement-layout-frame identifying unit 308. Alternatively, this determination may be made on the basis of the size of the layout frame. For example, if the size of the layout frame identified by the replacement-layout-frame identifying unit 308 is larger than a predetermined threshold, a photo for the layout frame may be regarded as an important photo for the user, and a photo mount may be selected as a recommended item. Also, the size of the photo mount may be determined in accordance with that of the layout frame. Alternatively, a recommended item may be determined on the basis of both the size and shape of the layout frame identified by the replacement-layout-frame identifying unit 308.

The recommended-item determining unit 311 may not be able to determine a single item on the basis of the size and shape of the layout frame in which a replacement operation has taken place. If a plurality of items are applicable, all the plurality of items may be displayed so that the user can select an item to order in combination with the recommended image.

In the example of FIG. 4A and FIG. 4B, for ease of understanding, a description has been given of the case where only one image replacement operation has taken place. However, there may be cases where a plurality of replacement operations have taken place. For example, images displayed in the candidate-image display area 406 may be laid out one after another in the layout frame 405, so that it is possible to determine a final layout while checking an overall composition of the photo book. In this case, all images except one finally laid out in the layout frame 405, that is, all images except one laid out in the layout frame 405 when the layout completion button is pressed may be determined to be recommended images. Alternatively, recommended images may be determined by one of the following methods.

A first method is to determine, of a plurality of images laid out one after another in the layout frame 405, an image that was laid out in the layout frame 405 immediately before layout of the final one to be a recommended image. It is likely that the user wondered whether to put this image into the photo book until just before the final decision. Therefore, by making a recommendation to the user to purchase this image in combination with another item, the user's willingness to purchase can be increased.

A second method is to select a recommended image from images except one finally laid out in the layout frame 405, on the basis of the number of times each image has been laid out in the layout frame 405. For example, assume that the user wondered which of the image 001 and the image 002 to put into the layout frame 405, tentatively laid them out alternately in the layout frame 405 multiple times, and made a final decision to lay out the image 001 in the layout frame 405. In this case, it is likely that the user wondered until the last minute whether to put the image 002 into the photo book. Therefore, by making a recommendation to the user to purchase the image 002 in combination with another item, the user's willingness to purchase can be increased. As described above, when there are a plurality of replaced images, an image laid out in the layout frame 405 most frequently or a number of times larger than a predetermined threshold may be determined to be a recommended image, so that sales can be promoted.

Since a photo book often has a plurality of layout frames with different shapes and sizes, the user may perform a layout operation while considering the composition of each image. For example, after initially laying out an image 006 in the layout frame 405, the user may think that the image 005 is more suitable for the layout frame 405, replace the image 006 with the image 005, and newly lay out the image 006 in the layout frame 402. In this case, although the image 006 is a replaced image for the layout frame 405, the image 006 can be purchased with being laid out in the layout frame 402. It may thus be less necessary to recommend that the image 006 be purchased in combination with another item. Therefore, if an image identified by the replaced-image identifying unit 307 is laid out in another layout frame, the image may not be selected as a recommended image. Thus, images that may be purchased by the user can be selected and displayed as recommended images.

As described above, the present embodiment focuses attention on the fact that an image replaced with another image during a layout operation is likely to be one that the user wondered whether to purchase. Thus, the user is recommended to purchase the replaced image in combination with another item. Therefore, even when direct sales pitches cannot be made, such as when the user places an order from home via a network, it is possible to make effective recommendations on the basis of user's psychology.

### Second Embodiment

In the first embodiment described above, an image on which a replacement operation has been performed is determined to be a recommended image. At the same time, in the first embodiment, a recommended item is determined on the basis of information (shape and size) about a layout frame in which the image was laid out. The present embodiment will describe an example in which a recommended item is determined on the basis of the number of images on which a replacement operation has been performed.

A system configuration and a configuration of the PC 104 are the same as those illustrated in FIG. 1 to FIG. 3, and their description will be omitted here.

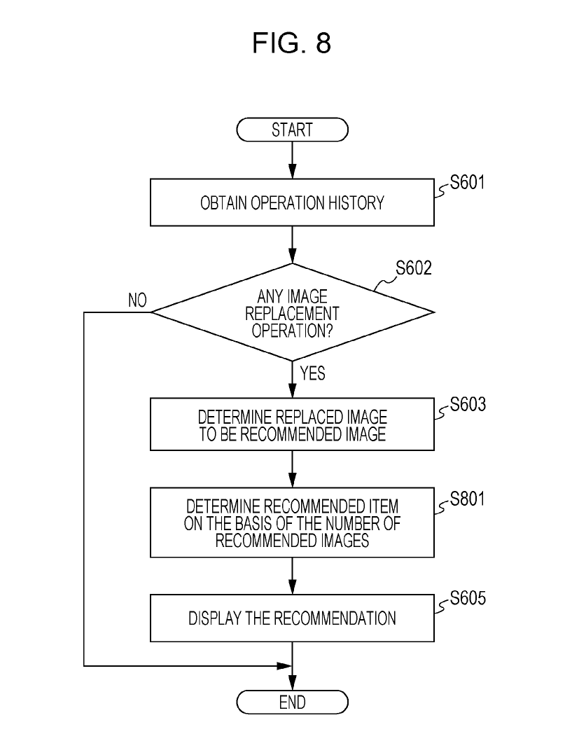

FIG. 8 is a flowchart illustrating an operation of the PC 104 according to the present embodiment. Steps identical to those illustrated in FIG. 6 are given the same reference numerals and their description will be omitted. In FIG. 8, step S801 is performed instead of step S604.

In step S801, the recommended-item determining unit 311 determines a recommended item on the basis of the number of recommended images determined by the recommended-image determining unit 310. Specifically, on the basis of information managed by the item managing unit 303, the recommended-item determining unit 311 selects, as a recommended item, an item on which the same number of images as that of recommended images can be laid out. For example, if the number of recommended images is three, a photo mount for three photos is selected as a recommended item.

If none of items managed by the item managing unit 303 allows the layout of the same number of images as that of recommended images, the recommended-item determining unit 311 may select a plurality of recommended items such that the total number of images that can be laid out on the recommended items can be equal to the number of recommended images. For example, if the number of recommended images is seven and there is no item which allows the layout of seven images thereon, a photo mount for six photos and a postcard may be determined to be recommended items. When a plurality of items are to be recommended, recommended images and recommended items may be displayed separately as illustrated in FIG. 7A so that the user can determine which image is to be printed on which item.

As described above, in the present embodiment, one or more recommended items are determined on the basis of the number of images replaced with other images during layout operations. Therefore, even if there are a plurality of images that the user probably wondered whether to purchase, one or more recommended items appropriate for the number of the images can be selected.

### Third Embodiment

The present embodiment will describe an example in which if an image replacement operation has taken place in a predetermined one of a plurality of layout frames within an item, the replaced image is determined to be a recommended image, and if an image replacement operation has taken place in a layout frame which is not the predetermined one, no recommended image is presented.

A system configuration and a configuration of the PC 104 are the same as those illustrated in FIG. 1 to FIG. 3. The layout-frame-information managing unit 304 also manages information for identifying whether a layout frame in which a replacement operation has taken place is a predetermined layout frame. For example, a large-size layout frame or a layout frame with a distinctive shape, such as a star-shaped frame or a heart-shaped frame, is set as the predetermined layout frame.

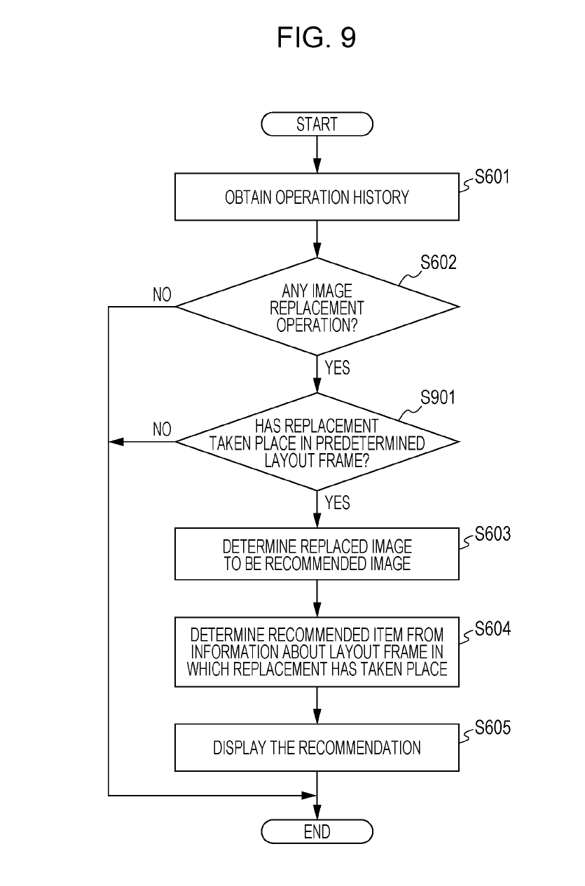

FIG. 9 is a flowchart illustrating an operation of the PC 104 according to the present embodiment. Steps identical to those illustrated in FIG. 6 are given the same reference numerals and their description will be omitted. In FIG. 9, step S602 is followed by a determination in step S901.

If it is determined in step S602 that any image replacement operation has taken place, the recommended-image determining unit 310 determines whether the layout frame in which the replacement operation has taken place is a predetermined layout frame (step S901). Specifically, a determination is made as to whether the layout frame identified by the replacement-layout-frame identifying unit 308 is managed as a predetermined layout frame by the layout-frame-information managing unit 304.

If the layout frame in which the replacement operation has taken place is a predetermined layout frame (YES in step S901), the replaced image identified by the replaced-image identifying unit 307 is determined to be a recommended image (step S603). If the layout frame in which the replacement operation has taken place is not a predetermined layout frame (NO in step S901), the recommended-image determining unit 310 ends the process without determining any recommended image.

As described above, in the present embodiment, a replaced image is presented as a recommended image only when the image replacement operation has taken place in a layout frame of large size or distinctive shape. It is likely that an image temporarily laid out in such a predetermined layout frame is of great importance to the user, but had to be removed from the layout, for example, due to a restriction on the number of images that can be laid out on an item. Therefore, by recommending the user to purchase such an image in combination with another item, it can be expected that the user's willingness to purchase will increase.

In the example described above, if a layout frame in which a replacement operation has taken place is not a predetermined layout frame, a replaced image replaced in the layout frame is not selected as a recommended image. Alternatively, regardless of whether a layout frame in which a replacement operation has taken place is a predetermined layout frame, a replaced image identified by the replaced-image identifying unit 307 may be determined to be a recommended image. Then, if the replaced image is an image replaced in the predetermined layout frame, the replaced image may be highlighted against other images when displayed as a recommended image in step S605. For example, such a replaced image may be displayed with a different background color or with a predetermined message so that the user can recognize that the displayed image is an image that is particularly recommended.

### Fourth Embodiment

The present embodiment will describe an example in which, of images replaced with other images by replacement operations, only an image preassigned a high priority is determined to be a recommended image.

A system configuration and a configuration of the PC 104 are the same as those illustrated in FIG. 1 to FIG. 3. Each image is preassigned priority information indicating a priority of the image. The priority information is divided into five levels, ranging from one to five. Favorite images or images of important scenes are assigned higher priorities. The priority information may be assigned by the user from the PC 104, or by a photographer for the photo studio from the photo-studio management apparatus 102. The image managing unit 302 manages the priority information assigned to each image.

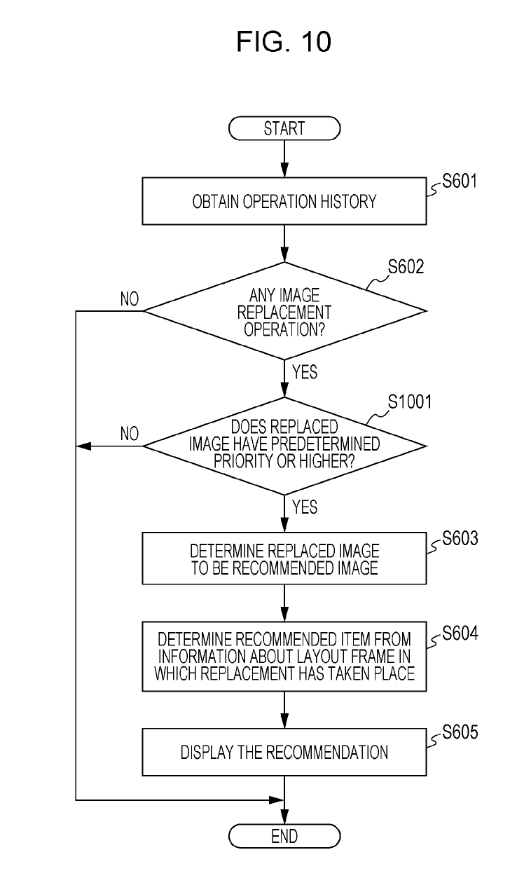

FIG. 10 is a flowchart illustrating an operation of the PC 104 according to the present embodiment. Steps identical to those illustrated in FIG. 6 are given the same reference numerals and their description will be omitted. In FIG. 10, step S602 is followed by a determination in step S1001.

If it is determined in step S602 that any image replacement operation has taken place, the recommended-image determining unit 310 determines whether the replaced image is an image with a predetermined priority or higher (step S1001). Specifically, the recommended-image determining unit 310 refers to information managed by the image managing unit 302 to determine whether priority information assigned to the replaced image identified by the replaced-image identifying unit 307 indicates a predetermined priority or higher (e.g., four or more).

If the priority information assigned to the replaced image indicates a predetermined priority or higher (YES in step S1001), the replaced image is determined to be a recommended image (step S603). If the priority information assigned to the replaced image indicates a priority lower than the predetermined priority (NO in step S1001), the replaced image is not selected as a recommended image.

As described above, in the present embodiment, only when, for example, a favorite image or an image of an important scene has been replaced with another image, the replaced image is presented as a recommended image. It is likely that the user had to remove such an image from the layout, for example, due to a restriction on the number of images that can be laid out on an item, or in consideration of the balance of the entire item. Therefore, by recommending the user to purchase such an image in combination with another item, it can be expected that the user's willingness to purchase will increase.

In the example described above, a replaced image that is assigned priority information indicating a priority lower than a predetermined priority is not selected as a recommended image. Alternatively, regardless of priority information assigned to each replaced image, all replaced images may be determined to be recommended images. Then, if a replaced image is assigned priority information indicating a predetermined priority or higher, the replaced image may be highlighted against other images when displayed as a recommended image in step S605. For example, such a replaced image may be displayed with a different background color or with a predetermined message so that the user can recognize that the replaced image is an image that is particularly recommended.

The method described in the first to fourth embodiments may be used in appropriate combinations.

For example, the method of the first embodiment (step S604 in FIG. 6) may be combined with the method of the second embodiment (step S801 in FIG. 8) to determine a recommended item. That is, a recommended item may be determined on the basis not only of the shape or size of a layout frame in which a replacement operation has taken place, but also of the number of images replaced with other images. Also, the method for determining a recommended item according to the third and fourth embodiments (step S604 in FIG. 9 and FIG. 10) may be replaced with or combined with the method of the second embodiment (step S801 in FIG. 8).

The method of the third embodiment may be combined with the method of the fourth embodiment to determine a recommended image. That is, only an image replaced in a predetermined layout frame and assigned priority information indicating a predetermined priority or higher may be determined to be a recommended image.

In the description above, all layout operations are stored as an operation history, as illustrated in FIG. 5. Alternatively, only when a replacement operation has taken place, information about a replaced image and a replacement layout frame may be stored.

In each of the embodiments described above, the PC 104 serves as an information processing apparatus and performs the entire process. Alternatively, the PC 104 may work together with the management server 103 to realize the process of each embodiment. That is, the management server 103 may include some of the functional blocks illustrated in FIG. 3, transmit or receive operation history information etc. to or from the PC 104 via the network 105, and thus perform a recommendation process. In this case, part of the program stored in the program memory 204 of the PC 104 is stored in a program memory of the management server 103, so that a CPU of the management server 103 executes the program. For example, the management server 103 may obtain an operation history from the PC 104 to determine a recommended image and a recommended item, and the PC 104 may only display the recommended image and the recommended item determined by the management server 103. Alternatively, the entire process may be performed by the management server 103.

In each of the embodiments described above, the user orders a laid-out item created by laying out images taken at the photo studio on an item, such as a photo book. However, the present invention is applicable to other cases. For example, the present invention is applicable to the case in which the user uses dedicated editing software to lay out images taken by a user's own camera on an item, such as a photo book, and orders the resulting laid-out item.

In each of the embodiments described above, a recommended item to be recommended as a layout target on which a recommended image is to be laid out is determined. However, it may not be necessary to determine a recommended item. That is, only an image whose purchase is to be recommended may be presented to the user, who may select an item on which an image to be purchased is to be laid out.

In each of the embodiments described above, if image replacement has taken place during a layout operation for laying out each image on an item, at least one image replaced with another image is presented to the user as a purchase recommendation. Thus, since an image that the user probably wondered whether to purchase is presented to the user, the user's willingness to purchase can be increased and it is possible to promote product sales.

The present invention is not limited to the embodiments described above, and may be variously changed and modified without departing from the spirit and scope of the present invention. To disclose the scope of the present invention, the following claims are appended.

According to the present invention, sales can be promoted by recommending a user to purchase an image that has been replaced with another image by an image replacement operation during a layout operation for a layout frame.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of International Patent Application No. PCT/JP2010/052713, filed Feb. 23, 2010, which is hereby incorporated by reference herein in its entirety.

What is claimed is:

1. A system for creating a medium having one or more images laid out thereon, the system comprising:
a storage unit adapted to store an operation history relating to layout operations, each laying out an image in a layout frame included in a first medium;
an identifying unit adapted to identify, on the basis of the operation history stored in the storage unit, an image removed from the layout frame by an image replacement operation;
a first determining unit adapted to determine at least one image identified by the identifying unit to be a recommended image whose purchase is to be recommended;
a second determining unit adapted to determine a second medium to be recommended as a layout target on which the recommended image determined by the first determining unit is to be laid out; and
a presenting unit adapted to present the recommended image and the second medium to a user.

2. The system according to claim 1, wherein the second determining unit determines the second medium on the basis of at least one of a shape and a size of the layout frame in which the replacement operation has taken place.

3. The system according to claim 1, wherein the second determining unit determines the second medium on the basis of the number of recommended images determined by the first determining unit.

4. The system according to claim 1, wherein the first determining unit determines, if the replacement operation has taken place in a predetermined one of a plurality of layout frames included in the first medium, at least one image removed from the predetermined layout frame to be the recommended image.

5. The system according to claim 1, further comprising a managing unit adapted to manage priority information for each image to be laid out on the first medium,
wherein the first determining unit determines the recommended image on the basis of priority information for an image identified by the identifying unit.

6. The system according to claim 1, wherein if a plurality of images are identified by the identifying unit, the first determining unit determines, as the recommended image, an image that was laid out in the layout frame immediately before layout of an image determined as an image to be laid out in the layout frame.

7. The system according to claim 1, wherein if a plurality of images are identified by the identifying unit, the first determining unit determines the recommended image on the basis of the number of times each image has been replaced with another image by the replacement operation.

8. The system according to claim 1, wherein an image removed from the layout frame by the replacement operation and determined as an image to be laid out in another layout frame in the first medium is not selected as the recommended image by the first determining unit.

9. A control method in a system for creating a medium having one or more images laid out thereon, the control method comprising:
obtaining an operation history relating to layout operations, each laying out an image in a layout frame included in a first medium;
identifying, on the basis of the obtained operation history, an image removed from the layout frame by an image replacement operation;
determining at least one identified image to be a recommended image whose purchase is to be recommended;
determining a second medium to be recommended as a layout target on which the recommended image is to be laid out; and
presenting the recommended image and the second medium to a user.

10. An information processing apparatus in a system for creating a medium having one or more images laid out thereon, the information processing apparatus comprising:
an identifying unit adapted to identify an image removed from a predetermined layout frame by an image replacement operation during a layout operation for laying out an image in the predetermined layout frame; and
a determining unit adapted to determine at least one image identified by the identifying unit to be a recommended image whose purchase is to be recommended.

11. A control method for controlling an information processing apparatus in a system for creating a medium having one or more images laid out thereon, the control method comprising:
identifying an image removed from a predetermined layout frame by an image replacement operation during a layout operation for laying out an image in the predetermined layout frame; and
determining at least one identified image to be a recommended image whose purchase is to be recommended.

12. A computer-readable recording medium which records a program to cause a computer to execute the control method according to claim 9.

13. A computer-readable recording medium which records a program to cause a computer to execute the control method according to claim 11.
